(19) United States
(12) Patent Application Publication
(10) Pub. No.: US 2006/0215988 A1
(43) Pub. Date: Sep. 28, 2006

(54) Recording of broadcast programmes

(76) Inventors: Ronald Marcel Tol, Eindhoven (NL); Johannis Friso Rendert Blacquiere, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/551,970

(22) PCT Filed: Apr. 5, 2004
(86) PCT No.: PCT/IB04/50395

§ 371 Date: Oct. 5, 2005

(30) Foreign Application Priority Data
Apr. 14, 2003 (EP) 03101002.8

(51) Int. Cl. H04N 5/91

(52) U.S. Cl. 386/83

(57) ABSTRACT

A recording system (75) includes a broadcast receiver (210) for receiving broadcast programmes, and a download receiver (280) for requesting and receiving content parts of a broadcast programme from a server (90). A controller (250) determines whether an instruction for recording a broadcast programme would exceed a capacity for recording and playback of programmes during at least part of the corresponding broadcast period. If so, the controller instructs a recorder (290) to record content parts of the broadcast programme during a part of the broadcast period in which the capacity is not exceeded and stores an identification of a content part of the broadcast programme that could not be recorded. It determines a period in which the capacity of the recorder is not exceeded and ensures that the not recorded content parts are downloaded from the server in the determined period and recorded.

### FIELD OF THE INVENTION

The invention relates to a system for recording broadcast programmes and to a method of recording broadcast programmes.

### BACKGROUND OF THE INVENTION

New forms of consumer electronics products are continually being developed. Many efforts have been focused on the convergence of computer technology and home entertainment systems that center on the television (TV) set. Important areas are interactive television and enhanced functionality, by merging broadcast television and Internet. WO 01/11874 describes a system wherein WWW uniform resource locators (URLs) are simulcast with TV signals. For example, URLs may be included into the vertical banking interval (VBI) of a broadcast TV signal or in a separate data channel of a digital TV video stream. When prompted by a message in the TV broadcast, the user may select one or more of the URLs to contact a web site over Internet and perform a transaction to obtain additional information relating to the broadcast. Such information may, for example, be information on the actors, directors, etc.

WO 01/11874 further describes that the broadcast receiver also includes a storage device. If the user wants to access the web site, display of the broadcast is temporarily halted and the web content is displayed on the screen. The broadcast programme is in the mean time recorded in the storage device and display of the programme is continued from storage when the user has finished accessing the web.

Storage capacity of recording capacity is continuously increasing. This enables having a media server in a home with a substantial library of recorded content, such as audio (e.g. in PCM or MP3 encoding), video (e.g. in MPEG encoding), still images (e.g. in JPEG encoding), etc. In particular, audio and/or video may be recorded from live broadcasts. The increasing power of the recording system is expected to also result in a significant increase in demand being made on the system. Users of the system may expect that each person in a home can simultaneously playback anything that is already stored in the system and record whatever is being broadcast. Naturally, there are limits to the storing and playback capacity of the recording system. These limits may lie in physical limitations, such as bandwidth, of the storage device but may also lie in limitations of the broadcast receiver that, for example, can only receive and decode one or two channels at a time. If in the known system capacity is exceeded, a broadcast programme will not be recorded. The user has simply missed the opportunity to record the broadcast.

### SUMMARY OF THE INVENTION

It is an object of the invention to provide an improved transmission system end recording system better capable of dealing with recording tasks that exceed the current capability of the system.

To meet the object of the invention, a transmission system includes a broadcasting system for broadcasting programmes, a download system including a server for storing content parts of at least some of the broadcast programmes in association with respective content part identifiers; and a communication system for on demand downloading of programme content parts stored in the server; and a recording system including a broadcast receiver for receiving broadcast programmes, a download receiver for requesting and receiving content parts from the server; a recorder including a storage system for storing received programmes and for playback of stored programmes; and a controller operative to determine whether an instructed recording of a broadcast programme would exceed a predetermined capacity of the recording system for recording and playback of programmes during at least part of a corresponding broadcast period; and if so, instruct the recorder to record content parts of the broadcast programme during a part of the broadcast period in which the capacity is not exceeded; store an identification of a content part of the broadcast programme that can not be recorded; determine a period in which the capacity of the recorder is not exceeded; instruct the download receiver to download the not recorded content part from the server in the determined period and instruct the recorder to record the downloaded content part in association with the broadcast programme.

According to the invention, content parts of some (or preferably all) programmes being broadcast are also stored in a server. Preferably, the entire programme is stored in the server. If a recording task exceeds the capability of the system (e.g. the user wishes to record two broadcast programmes during a partially overlapping period and the broadcast receiver and/or recorder is not capable of doing this) at least one recording task is halted during the period in which the capacity is exceeded. The system administrates which content part of the programme is then not recorded. This missing part is downloaded from a server at a moment the system does have the capacity and is then recorded in association with the programme, i.e. combined with the part (if any) that was already recorded during the live broadcast. The temporary lack of capacity may have many causes, including too many playback tasks that must be performed during the recording period. The system is able to identify the content parts being broadcast and select the not recorded parts from the server. Any suitable content part identification may be used. For example, the recording system may store a broadcasting timestamp, where the server maintains a table mapping the broadcast timestamp to stored parts. The content parts may also be associated with characteristic point information (CPI) in a way known from DVR (Blu Ray Disc).

According to the measure of claim 2, whenever capacity is exceeded the controller is capable of selecting between the conflicting tasks. In a preferred embodiment, as described in the dependent claim 3, it is checked whether a programme to be recorded is available on the server for subsequent downloading. If so, it is not necessary to perform a live recording of this programme. Priority can be given to other recording and/or playback tasks.

According to the measure of the dependent claim 3, broadcast programmes are associated with an identifier. The identifier is used to check whether a programme to be broadcast is available for later downloading in the server. If so, recording can be delayed without serious consequences. If not, it is preferred to record the live broadcast (unless all of the other tasks that are candidates for being halted are even more important).

According to the measure of the dependent claim 4, each broadcast programme is associated with at least one programme attribute. The controller is programmed to give priority to executing a recording task relating to a programme with at least one predetermined programme attribute. The programme attribute of a programme to be recorded is a parameter in the decision making process.

According to the measure of the dependent claim 5, the programme attribute includes at least one of the following:
programme category, like sport, movie, news, game shows, etc
broadcast channel, e.g. channel number name (like BBC)
programme language, e.g. English, German, Japanese, Dutch, etc.
additional metadata or programme information, like main actor/actress, director, recording studio, name of the programme, etc.
coding information, such as aspect ratio (e.g. 4:3 or 16:9), coding type (e.g. MPEG), etc.

For example, priority may be given to events that are one-off events, such as typically is the case for programme categories like news and sport.

According to the measure of the dependent claim 6, the system has a user profile and uses the profile for deciding which task to halt/execute during a period of a capacity conflict. Preferably, the profile includes at least one of the following:
preferred programme categories
preferred broadcast channels
preferred programme language,
preference for playback or recording,
preferred metadata,
preferred aspect ratio.

Preferably, the system interacts with the user if there is a conflict. The system may then present all relevant information (such a programme category, whether or not the programme can be downloaded subsequently, etc.). The user can then decide. It is preferred that the system uses the input to optimize the rules/profile it uses to decide/propose which task to execute/halt. The user can then, at a certain moment, instruct the system to operate fully automatically, possibly only providing its decision to the user. In the latter case, the user only needs to intervene if the user disagrees with the decision.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a digital broadcast system wherein the invention can be used; and

FIG. 2 shows a block diagram of a receiver for use in the system.

### DETAILED DESCRIPTION OF THE PREFERRED EMBODIMENT

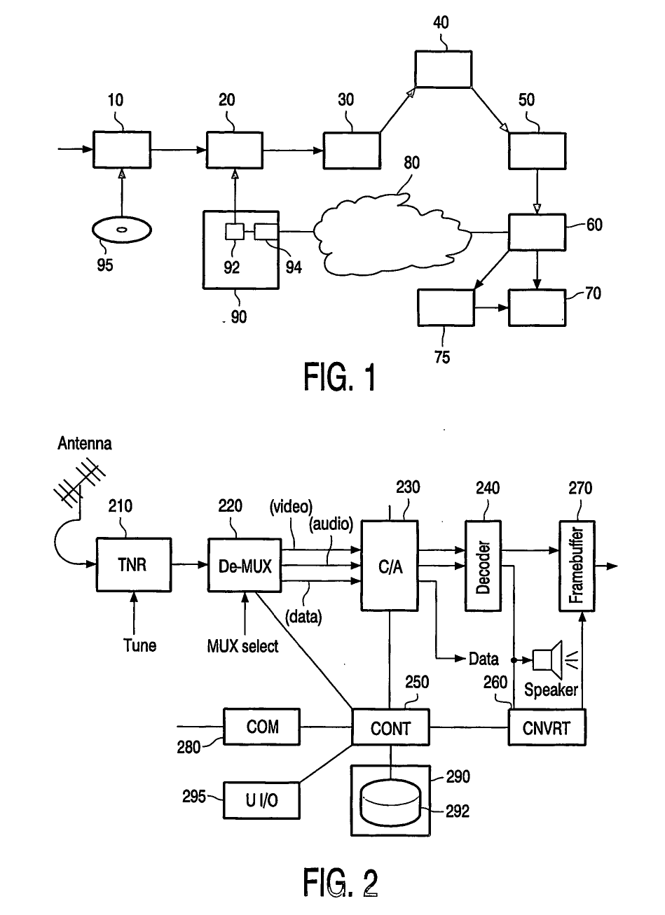

FIG. 1 gives an overview of a digital television system in which the receiver according to the invention can be used. As an example, a system is described wherein the audio/video (A/V) signals are distributed digitally using MPEG-2 compression to compress the A/V signals. The system includes a broadcasting system (10, 20, 30, 40), a download system (80, 90) and a recording system (50, 60, 75). The broadcasting system includes an MPEG-2 compressor 10, usually located in a broadcast centre. The compressor receives a digital signal stream (typically a stream of digitized analog or digital video signals). The original signals are supplied by a service provider. The compressor is connected to a scrambler and multiplexer 20. The scrambler scrambles the digital signals of a data stream by encrypting them under control of a content key, as will be described in more detail below. The multiplexer 20 may receive in addition to one or more scrambled or non-scrambled data stream also further digital signals. The multiplexer 20 assembles all the signal and streams into a transport stream and supplies the compressed and multiplexed signals to a transmitter 30 of the broadcast centre. The scrambling and multiplexing functions may be performed in separate units, and if desired at different locations. The multiplexed transport stream may be supplied from the scrambler/multiplexer 20 to the transmitter 30 using any suitable form of linkage, including telecommunication links. The transmitter 30 transmits electromagnetic signals via an uplink towards a satellite transponder 40, where they are electronically processed and broadcast via a downlink to an earth-based satellite receiver 50, conventionally in the form of a dish of the end user. In the figure, the satellite receiver 50 is connected to a recording system with an integrated receiver 60. The operation of the recording system 60 is described in more detail below with reference to FIG. 2. The receiver selects the desired signal and presents it in a suitable form to a rendering device, such as a television 70. The signal may also be recorded by a recorder 75, for example, using a tape, optical disc or hard disk recorder or other suitable recorder. The signal may be supplied to the rendering/recording device in an analog or digital form using well-known distribution systems such as CATV cable, or IEEE 1394. For digital distribution only partial decoding of the transport stream is required, where the de-multiplexed signals are supplied in the MPEG-2 coding using partial transport streams. It will be understood that the main distribution of the AV signals does not need to take place via satellite. Instead other delivery systems (i.e. the physical medium by which one or more multiplexes are transmitted) may be used, such as terrestrial broadcast, cable transmission, combined satellite/cable. The party that distributes the program via the delivery system is sometimes referred as the network provider. It will also be understood that the receiver/decoder 60 may be integrated into the rendering device or recording system.

A typical system operates as a multi-channel system, implying that the multiplexer 20 can handle A/V information received from a number of (parallel) sources and interacts with the transmitter 30 to broadcast the information along a corresponding number of channels or multiplexed into separate transport streams. In addition to A/V signals, messages or applications or any other sort of digital data may be introduced in some or all of these services/channels interlaced with the transmitted digital audio and video information. As such a transport stream includes one or more services, each with one or more service components. A service component is a mono-media element Examples of service components are a video elementary stream, an audio elementary stream, a Java application (Xlet), or other data type. A transport stream is formed by time-multiplexing one or more elementary streams and/or data.

According to the invention, communication is enabled in the system to facilitate downloading of content parts of a programme that could not be recorded during the live broadcast of the title. The content parts are downloaded from a download system 90, including a server 92 and a communication system 94. Preferably, the communication is bi-directional. Advantageously, the same communication is also used for interactive applications, such as interactive video, e-commerce and so on, and to enable the receiver to obtain additional information/functionality from a web site on the server 92. Shown is the use of a wide area network 80, preferably the open Internet, where the added functionality and interactivity is provided by a web site on a server 92. The content parts to be recorded are typically downloaded on demand by a receiver/recorder. Other added functionality that is stored in the server may be broadcast or multicast from the server. To this end, preferably, the server 92 also has a connection to the multiplexer 20. This may be a direct link but may also be via the Internet. It will be understood that the communication functionality of Internet or similar communication system may be provided in any suitable form. For example, the receiver may communicate via a cable network or satellite connection, directly using Internet protocols. Alternatively, the receiver may have a telephone-based dial-in connection to an access provider that provides access to the Internet. The receiver may, but need not use Internet protocols. If the server 92 does use Internet protocols, protocol conversion may take place, for example using a gateway.

Although the system according to the invention is described for a conventional digital broadcast system, in principle the invention can also be applied for non-conventional broadcast transmissions. For example, the same concepts can be applied where a programme is supplied to a group of receivers where an individual receiver can not control the start of a transmission or cannot easily interrupt a recording of a transmission without loosing content parts.

The described broadcasting system broadcasts programmes, typically audio/video (AV) programmes. FIG. 1 shows a removable storage medium 95, such as CD-ROM, DVD, or solid state memory, which stores AV data. Typically, the AV programme is a movie or similar AV data. For such a programme, enhanced functionality may already have been developed. Usually, the programme was stored in a compressed form, for example using MPEG-2 coding. For transmission, the programme may be changed, for example some parts may be removed, for example to reduce the length, and some other part, like commercials, may be added. Consequently, the programme will usually be re-coded. Using the exemplary digital transmission system of FIG. 1, this is shown by feeding the programme through the coder 10. The programme will anyhow be multiplexed into the transport stream by the multiplexer 20. Of course, the programme need not be taken from the storage medium 95 but may also in an original version be supplied by a studio.

According to the invention, the server 92 includes a storage for storing content parts of at least some of the broadcast programmes. The parts are stored in association with respective content part identifiers. The communication system 94 enables downloading of selective parts of the stored content on demand by indication the content parts using the identifier or other identifying information that can be converted to the stored identifier. The server is preferably implemented using hardware/software that is conventional for web servers or video on demand servers. The storage may, for example, be based on a RAID system. Preferably, the server stores content parts of each programme broadcast by a service provider. It may store only part of the title (e.g. the last half of the programme). It will be appreciated that it is preferred that the entire programme is stored. The download system may also include a payment system for payment of downloads. The payment may, for example, be on a subscription basis, or on a usage basis (e.g. per programme, per amount of downloaded data, or per time duration of the playback time of the downloaded part). The downloaded content may be protected using conditional access techniques.

In a further embodiment, enhanced functionality for the programme, that has been broadcast or is being broadcast, is available via the Internet through a web site. The web site may, but needs not, be on the same server as the one used for downloading the not-live recorded content parts. In the description here, it is assumed that the additional information is also provided via the download system 90. The web site on the server 92 may contain many additional information parts, of which some have a clear correspondence with content parts of the programme. For example, the web site may include more subtitles or languages than in the broadcast programme. For example, a DVD may have been supplied in different versions for different regional areas. As the different versions are developed more languages and sub-titles may be developed as well. These languages and sub-titles can be stored in the server 92 and provided from the server during the live broadcast, preferably synchronous to the broadcast. The additional information may be provided from the server to the broadcast system or through the download system. It may also be downloaded at a later moment for subsequent recording or for synchronous playback with a playback of the stored content. As a further example, the server may store interviews with the director, script writers, or actors, where parts of the interview link to content parts being discussed. In this way, the viewer watching the interview (retrieved from the web site) can also view the content parts being discussed. Similarly, games and quizzes may be developed and made available through the web site that may or may not link web-based content to the programme content. Further examples of enhanced functionality are:
Enhanced menu structures (e.g. downloading of menus similar to those on a DVD)
Favorite scene selection (e.g. with specific selections per user group, e.g. depending on age or sex of a viewer)
E-commerce, buying items related to the movie
Karaoke-type subtitling, and a separate audio stream with only the instruments
Promotion of similar/related movie titles
Alternative ending to a movie
Provide up-to-date profiles of actors, directors, etc.

The enhanced functionality can be used to adapt the broadcast content to a specific audience. The type of audience may be explicitly indicated by the user or automatically determined based on the use of the system by the user, resulting in the creation of a user profile. In itself it is known how automatically user profiles can be created based on the usage of a system. This will not be described further here.

FIG. 2 shows more details of a typical recording system with an integrated broadcast receiver. Such a recording system may, for example, be a hard disk equipped television, a set top box (STB), personal video recorder (PVR), home gateway or home media server, such as defined in the Universal Plug and Play (UPnP) standard. The broadcast receiver, preferably, complies with a defined platform like the European MHP (Multi-media Home Platform) or the US DASE platform. The broadcast receiver includes a tuner 210. The tuner 210 extracts a separate tunable Radio Frequency (RF) band usually resulting in an MPEG2 transport stream. Variable data signals are separated from the constant carrier signal by the de-multiplexer 220 (De-MUX). The results often are audio, video and data outputs. The video and audio streams may be fed through a Conditional Access subsystem 230, which determines access grants and may decrypt data. The audio and video streams are fed to a decoder 240, which converts them into signals appropriate for the video and audio rendering or storage devices. This may involve MPEG2 decoding. The receiver also includes the communication interface 280 for bi-directional communication to the download system 90. Any suitable communications hardware/software may be used for this, including conventional modems for standard telecommunication lines or broadband modems. According to the invention, the bi-directional communication channel facilitates downloading of content part of programmes that have been broadcast and were not recorded at that moment due to lack of capacity in the recording system. The communication channel is preferably also used for receiving interactive applications, such as interactive video, e-commerce and so on, and obtaining additional information/functionality from the web site on the web server 92 of FIG. 1. Preferably, Internet protocols are used, for example those defined in the MHP “Internet Access Profile”. The relevant data retrieved from the web site will be converted by a converter 260 (such as an audio D/A converter and a graphics processor) to a suitable form for recording and for presentation to a user, for example via a loudspeaker and/or video display. The video may be combined with the video generated by the decoder 240 into one frame buffer 270. In this way, the web-data may be overlaid (e.g. as sub-titles, or as a Picture-in-Picture), or mixed with the video signal. Output of the decoder can be supplied to a rendering device and/or recorder 290 for subsequent rendering. Shown is an internal recorder 290 with a storage 292. The storage may be of any suitable type, such as a hard disk, or optical storage (e.g. DVD+RW, DVR, etc). Typically, the output is first stored in a frame buffer 270 for subsequent supply to the rendering/storage device. For certain applications, the receiver may provide encoded output streams, bypassing the decoder 250. The rendering device may then include the decoder function or the encoded stream may at a later stage be re-supplied to the receiver for further decoding. The encoded data stream may also be recorded in the storage 292 for subsequent rendering. A user interface 295 of the recording system enables the system to interact with the user. The user interface 295 may include any suitable user input means, such as an Infrared receiver for receiving signals from an IR remote control, a keyboard, or a microphone for voice control. For output, also any suitable form may be used, such as using a small LCD display or using the display of a television, or even audible feedback.

It will be appreciated that the various functions, such as the tuner function 210, the de-multiplexer function 220, the optional descrambler/decryptor function 230, and the decoder function 240 may be performed using dedicated hardware. Some functions or part of the functions may also performed by a programmable processing function, for instance using a digital signal processor (DSP) loaded with a suitable program. The various functions within the recording system are operated under control of the controller 250, which typically includes an embedded microprocessor or microcontroller. The controller operates under control of a suitable program. The program is typically loaded from a non-volatile memory, such as a ROM. Preferably, the program is updateable, e.g. via downloading or via a removable storage medium. The program is then stored in a rewriteable non-volatile memory, such as a hard disk or flash memory. To keep the figure simple, the control relationship between the controller and the other functions are not shown. Only the role that the controller can have in recording the broadcast/downloaded content parts, managing the storing/playback capacity, processing of the web data and synchronizing the presentation of AV content and web content are shown. For presenting the web content, the controller may execute an application similar to web browsers known from PCs. It will be appreciated that for certain information a much simpler application may be used. For example, sub-titles retrieved from the Internet can be overlaid in a way that Teletext sub-titles are overlaid. The user needs not to be aware that the actual added content is retrieved from the web.

According to the invention, the controller 250 manages at least the capacity of the recording system for recording and playback of programmes. The capacity may include the number of programmes that can be received simultaneously by the broadcast reception subsystem (tuner, de-multiplexer, conditional access system, decoder), that can be recorded simultaneously, that can be played back simultaneously, etc. The capacity of these items may have a dependency, for example playback and recording typically share an interface to the storage and share the same read/write head. Thus, playback operations will reduce the recording capacity and vice versa. The controller 250 can receive an instruction to record a broadcast programme, typically via the user interface 295. The instruction may also be received via other means, such as an in-home network. The instruction includes an identification of the programme, such as a channel number. The user may also indicate the period of broadcasting of the programme. Alternatively, the controller may retrieve this information automatically, for example from an electronic programme guide (EPG). The controller knows the current recording and playback tasks. It may also know some future tasks (already programmed automatic recordings or playback operations). Typically, the controller maintains such information in a memory, such as a RAM. Based on this information, the controller determines whether the instructed recording of the broadcast programme would exceed the predetermined capacity during at least part of the corresponding broadcast period. If so, the controller ensures that those parts of the live broadcast are recorded that take place when there is sufficient capacity in the recording (i.e. no conflicting tasks that cannot be executed in parallel). The controller also stores an identification of the content parts of the broadcast programme that could not be recorded during the live broadcast due to lack of capacity. It then determines a period in which the capacity of the recorder is not exceeded. During such a period, it instructs the download receiver to download the not recorded content parts from the server and instructs the recorder to record the downloaded content part in association with the broadcast programme. So, after completion of the download the entire programme has been recorded as if it were received in one operation.

In a preferred embodiment, whenever capacity is exceeded that controller is capable of selecting between the conflicting tasks. Advantageously, the controller checks whether a programme to be recorded is available on the server for subsequent downloading. It may use a programme identifier for this verification. If there are several overlapping recording tasks, the controller preferably checks for each of those tasks whether the programme is available in the server for downloading. A programme does not need to be recorded during the live broadcast if it is available in the server for downloading at a period subsequent to the broadcast when there is sufficient capacity. If already available in the server before the actual broadcast of the programme, the programme parts that can not be recorded live can already be recorded via downloading before the start of the actual broadcast. Also such programmes do not need to be recorded live. Priority can be given to other recording and/or playback tasks.

In a preferred embodiment, one or more programme attributes of a programme to be recorded are used in the decision making process. The controller may retrieve the programme attributes from an EPG or from a web site, e.g. from the server 92. The controller is programmed to give priority to executing a recording task relating to a programme with at least one predetermined programme attribute, such as a news broadcast. The controller preferably stores the attributes for each task to be executed, so that it can perform the decision making at every suitable moment (e.g. when it receives a new playback or recording instruction).

Preferably, the system has a user profile and uses the profile for deciding which task to halt/execute during a period of a capacity conflict. Preferably, the profile includes for which of the programme attributes the user has a preference. In addition it may include a preference for giving priority to playback or to recording in case of a conflict. The controller ensures that the profile is stored, preferably in non-volatile memory, such as the storage 290 or solid state memory like flash memory. Advantageously, the controller automatically compiles and adjusts the profile based on the behavior of the user. The controller may also enable a user to define and/or adjust the profile, for example in the form of rules.

Preferably, the system interacts with the user through the user interface if there is a conflict. The system may then present all relevant information (such a programme category, whether or not the programme can be downloaded subsequently, etc.). The user can then decide which task(s) should be executed during the period of lack of capacity. It is preferred that the system uses the input to optimize the rules/profile it uses to decide/propose which task to execute/halt. The user can then, at a certain moment, instruct the system to operate fully automatically, possibly only providing its decision to the user. In the latter case, the user only needs to intervene if the user disagrees with the decision.

It will be appreciated that the controller is able to identify the content parts being broadcast and select the not recorded parts from the server. Any suitable content part identification may be used. For example, the recording system may store a broadcasting timestamp, where the server maintains a table mapping the broadcast timestamp to stored parts. The content parts may also be associated with characteristic point information (CPI) in a way known from DVR (Blu Ray Disc). It is then preferred that the recording system and the server use the same rules for associating CPIs with content part (e.g. labeling each I-frame of an MPEG-2 stream with a CPI tag, or inserting a chapter every minute).

An example of a mapping will be described for MHP. MHP defines Normal Play Time (NPT) which is included in the Transport Stream that is broadcast and is accessible to the applications. It provides a continuous monotonically increasing time base independent of any timing discontinuities in the broadcast. NPT does not need to be included in a broadcast but is part of MHP and so can be used in this case to define the time relation between the stored content and the broadcast. The NPT can also be paused for some time e.g. during a commercial break the NPT of the main programme will pause. There may be multiple NPTs in the broadcast but only one can be increasing at any point in time e.g. the NPT of the main programme may be paused during an inserted news bulletin during which a separate NPT will increase. Essentially, the NPT is an offset from the Transport Stream timing (based on PCR) but without discontinuities. PCR is an acronym from MPEG-2 Transport Stream. It stands for Program Clock Reference and it is the basic timing in the Transport Stream along with the PTS/DTS times (Presentation Time Stamp and Display Time Stamp). The PCR is repeated in the Transport Stream (e.g. every 100 ms) to give the current time and the PTS/DTS refer to the same time base as the PCR.

A broadcast programme is recorded in a storage, such as the internal storage 290 of FIG. 2. In storing a broadcast programme, also a mapping from the broadcast timing to locations on storage, such as a recordable disc, may be stored. This allows support for jumping a certain time within the programme and trick play (for many applications it may be sufficient to store time/location for MPEG-2 I-frames). This mapping enables finding a location in the storage based on the timing in the broadcast. Similarly, when the programme is stored in the server 92, the server can also store a mapping of locations in its storage to broadcast timing. In this way, identification can take place based on the broadcast timing that is present in the mapping table of the server and of the receiver. Instead of or in addition to the broadcast timing, the mapping table may use CPIs as described above.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and “include” and its conjugations do not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. A computer program product may be stored/distributed on a suitable medium, such as optical storage, but may also be distributed in other forms, such as being distributed via the Internet or wired or wireless telecommunication systems. In a system/device/apparatus claim enumerating several means, several of these means may be embodied by one and the same item of hardware. The mere fact that certain measures are recited in mutually different dependent claims does not indicate that a combination of these measures cannot be used to advantage.

1. A transmission system including:
a broadcasting system (10, 20, 30, 40) for broadcasting programmes,
a download system (90) including a server (92) for storing content parts of at least some of the broadcast programmes in association with respective content part identifiers; and a communication system (94) for on demand downloading of programme content parts stored in the server;
a recording system (75) including:
a broadcast receiver (210) for receiving broadcast programmes,
a download receiver (280) for requesting and receiving content parts from the server;
a recorder (290) including a storage system (292) for storing received programmes and for playback of stored programmes; and
a controller (250) operative to:
determine whether an instructed recording of a broadcast programme would exceed a predetermined capacity of the recording system for recording and playback of programmes during at least part of a corresponding broadcast period; and
if so, instruct the recorder to record content parts of the broadcast programme during a part of the broadcast period in which the capacity is not exceeded; store an identification of a content part of the broadcast programme that can not be recorded; determine a period in which the capacity of the recorder is not exceeded; instruct the download receiver to download the not recorded content part from the server in the determined period and instruct the recorder to record the downloaded content part in association with the broadcast programme.

2. A transmission system as claimed in claim 1, wherein the controller is operative to, if the task of recording of the broadcast programme would exceed the predetermined capacity, determine at least one conflicting recording or playback task that causes the lack of capacity, and to select which task not to execute during a period of the broadcast in which there is not sufficient capacity.

3. A transmission system as claimed in claim 2, wherein each broadcast programme is associated with a programme identifier, and wherein content parts are stored in the server in associating with a programme identifier; the controller being operative to give priority to halting a recording task involving a broadcast programme stored in the server.

4. A transmission system as claimed in claim 2, wherein each broadcast programme is associated with at least one programme attribute; the controller being operative to give priority to executing a recording task relating to a programme with at least one predetermined programme attribute.

5. A transmission system as claimed in claim 2, wherein the programme attribute includes at least one of the following:
programme category
broadcast channel
programme language,
metadata,
coding information.

6. A transmission system as claimed in claim 2, wherein the controller is operative to select from conflicting tasks based on a profile of a user of the recording system.

7. A transmission system as claimed in claim 6, wherein the profile includes at least one of the following:
preferred programme categories
preferred broadcast channels
preferred programme language,
preference for playback or recording,
preferred metadata,
preferred coding.

8. A transmission system as claimed in claim 2, wherein the controller is operative to enable a user to select from conflicting tasks through a user interface.

9. A recording system for use in a transmission system as claimed in claim 1; the recording system including:
a broadcast receiver (210) for receiving broadcast programmes,
a download receiver (280) for requesting and receiving content parts from the server;
a recorder (290) including a storage system (292) for storing received programmes and for playback of stored programmes; and
a controller (250) operative to:
determine whether an instructed recording of a broadcast programme would exceed a predetermined capacity of the recording system for recording and playback of programmes during at least part of a corresponding broadcast period; and
if so, instruct the recorder to record content parts of the broadcast programme during a part of the broadcast period in which the capacity is not exceeded; store an identification of a content part of the broadcast programme that can not be recorded; determine a period in which the capacity of the recorder is not exceeded; instruct the download receiver to download the not recorded content part from the server in the determined period and instruct the recorder to record the downloaded content part in association with the broadcast programme.

10. A method of recording broadcast programmes; the method including:
determine whether an instructed recording of a broadcast programme would exceed a predetermined capacity a recording system for recording or playback of programmes during at least part of the corresponding broadcast period; and
if so, instructing the recording system to record content parts of the broadcast programme during a part of the broadcast period in which the capacity is not exceeded; storing an identification of a content part of the broadcast programme that could not be recorded; determining a period in which the capacity of the recorder is not exceeded; instructing a download receiver to download the not recorded content parts from the server in the determined period and instructing the recording system to record the downloaded content part in association with the broadcast programme.

11. A computer program product operative to cause a controller in a recording system to execute the method of claim 10.
